(19) United States
(12) Patent Application Publication
(10) Pub. No.: US 2002/0070270 A1
(43) Pub. Date: Jun. 13, 2002

(54) Award point service system, recording medium for use therein and award point service method

(75) Inventors: Yuichi Narita, Kawasaki-shi (JP); Hiroshi Nakamoto, Saitama-shi (JP); Toru Matsumoto, Nagoya-shi (JP); Hiroshi Furugane, Nagoya-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 09/988,333

(22) Filed: Nov. 19, 2001

(30) Foreign Application Priority Data
Nov. 20, 2000 (JP) 2000-353507

(51) Int. Cl. G06F 17/00

(52) U.S. Cl. 235/375

(57) ABSTRACT

A virtual store server is provided in a virtual store of at least one of tie-up companies. The virtual store is established on the internet so as to issue points to a member upon access to the virtual store. The virtual store server includes a virtual store point DB for recording the number of the issued points. When the member makes a purchase in the actual store with the number of points that has been read by at least one terminal provided in an actual store, the terminal functions in reducing the number of points that has been read and used in the actual store.

### INCORPORATION BY REFERENCE

The disclosure of Japanese Patent Application No. 2000-353507 field on Nov. 20, 2000 including the specification, drawings and abstract is incorporated herein by reference in its entirety.

### BACKGROUND OF THE INVENTION

1. Field of the Invention

The present invention relates to an award point service system for sales promotion activities accompanied by a commercial transaction.

2. Description of Related Art

Recently, increasing number of companies have opened their own e-commerce sites in the Internet. JP-A-10-78987 discloses a point service system having a device for issuing a point to a customer who purchases an article in a virtual store and a device for reducing the point used by the customer from stored points such that sales of the virtual store is promoted. Assuming that a company operates both an actual store and a virtual store in which substantially the same items of the article are sold, the e-commerce using the virtual store may decrease the sales of the actual store. Particularly, if such company franchises those stores, the decrease in the sales of the individual actual store may cause a serious problem.

In the foregoing problem, the service system that promotes sales of the actual store while developing the sales of the virtual store has been demanded. For example, JP-A-11-73457 discloses a customer control system in which a certain number of points are issued to a customer who responds to the information delivered through an E-mail. Then a shopping ticket or a coupon will be issued corresponding to the added points so as to allow the customer to use the points for purchasing in the actual store.

In the above case, since the shopping ticket or a coupon can be easily copied, it is unlikely that the shopping ticket or the coupon that is worth a high priced article be issued. Accordingly, the shopping ticket or the coupon that is worth a low priced article is only issued. As the resultant service range is restricted to the low-priced article, this system fails to provide an attractive service to customers. Additionally, the shopping ticket or the coupon is not issued until the stored points reach a predetermined level. In this system, the customer is not allowed to use a small number of points from the stored points.

### SUMMARY OF THE INVENITON

It is an object of the invention to provide an award point service system that provides an attractive service to customers.

An award point service system includes a point issuing device that issues points to a customer who purchases an article, a memory that stores data of the points issued to the customer, a data access permitting device that permits the data of the points issued to the customer to be read from the memory, and a point reducing device that allows use of at least a part of the points read from the memory by subtracting the at least points from the data of the points stored in the memory. In this point service system, at least one virtual store established on a network is accessible to the point issuing device; and at least one actual store is accessible to the point reducing device. This allows the customer to use the points issued by the virtual store so as to purchase an article in the actual store. Therefore the customer is able to enjoy more attractive service.

In the point service system, at least one actual store is accessible to the point issuing device. This allows the customer to use the points issued by the virtual and the actual stores so as to purchase an article in the actual store. As a result, the customer may have more chance to use the points in the actual store, resulting in the attractive service for the customer.

In the point service system, at least one virtual store is accessible to the point reducing device. This allows the customer to use the points issued by the virtual stores so as to purchase an article in the virtual store. As a result, the customer who has difficulty in access to the actual store because of, for example, the distance between the actual store and the customer is allowed to use the points in the virtual store, resulting in improved convenience.

The point service system includes a managing device that manages the points issued by the point issuing device and the points reduced by the point reducing device. This may realize an integrated control of points which have been issued and reduced irrespective of the increase in the virtual and actual stores.

In the point service system, the data access permitting device includes a terminal provided in the actual store, and the terminal receives the data of the points from a recording medium owned by the customer and supplies the recording medium with the data of the points.

In the above case, the point data can be exchanged between the terminal and the recording medium, that is, the point data do not have to be read from a data storage device connected via a communication network. This may reduce the communication cost, as well as reduce the cost for the point service system for sales promotion disbursed in the actual store.

A recording medium is used in the point service system including an award point issuing device that issues points to a customer who purchases an article, a memory that stores data of the points issued to the customer, a data access permitting device that permits the data of the points issued to the customer to be read from the memory, and a point reducing device that allows use of at least a part of the points read from the memory by subtracting the at least points from the data of the points stored in the memory. In this system, the recording medium transmits and receives the data of the points to and from the data access permitting device, and the recording medium stores the points issued or reduced by any of at least one virtual store and at least one actual store. Consequently, the customer is allowed to use the points that have been issued by the virtual store to purchase an article in the actual store, resulting in the attractive service. The recording medium can be used in the aforementioned system for controlling the point data. Therefore, The point data can be read through the recording medium that is held by the customer. As the point data do not have to be read through the communication network, the communication cost can be further reduced.

An award point service management method includes the steps of issuing points to a customer who purchases an article in at least one of virtual stores established on a network, recording the issued points, and subtracting points used by the customer from the data of the points stored in a memory in at least one of actual stores such that the points are used by the customer for purchasing an article in the at least one of actual stores. The customer is allowed to use the points that have been issued by the virtual store to purchase an article in the actual store, resulting in the attractive service for the customer.

An award point service system includes a point issuing device that issues points to a customer who purchases an article, a memory that stores data of the points issued to the customer, a data access permitting device that permits the data of the points issued to the customer to be read from the memory, and a point reducing device that allows use of at least a part of the points read from the memory by subtracting the at least points from the data of the points stored in the memory. In the system at least one virtual store established on a network is accessible to the point reducing device; and at least one actual store is accessible to the point issuing device. Therefore, the points issued by the real store upon purchasing commodity for example can be used when purchasing another commodity at the virtual store. Thus, a more attractive service can be provided to the customer.

In the point service system, at least one virtual store is accessible to the point issuing device. One or plural virtual stores in the point service system of the present invention have the giving means. Therefore, the points issued by both the actual store and the virtual store can be used in the virtual store. For this reason, the service becomes more attractive.

In the point service system, at least one actual store is accessible to the point reducing device. Therefore, the issued points can be used in the actual store and the customer may have more chance to use the points.

In the point service system, the memory includes a first memory that stores points issued to the customer in the virtual store and a second memory that stores points issued to the customer in the actual store. Thus, the points issued by the virtual store and the points issued by the actual store can be controlled separately. For example, the customer is allowed to make a purchase in the actual store with the points issued by the virtual store. Meanwhile, the points issued by the actual store are only used in the actual store. Therefore, a certain error that occurs in one of the actual and virtual stores will not influence the other store.

In the point service system, the data access permitting device includes a terminal provided in the actual store, and the terminal receives the data of the points from a recording medium owned by the customer and supplies the recording medium with the data of the points. As data of the points are exchanged between the terminal and the recording medium, the data may be read from the recording medium, that is, the data do not have to be read from the memory connected via the communication line. As a result, the communication cost can be minimized, resulting in reduction of the cost for operating the point service system in the actual store.

In the point service system, the recording medium is formed as a medium used for making a payment. As the settlement function is included in the recording medium such as the IC card, the customer is allowed to make a purchase with no cash but the IC card.

### BRIEF DESCRIPTION OF THE DRAWINGS

FIG. 1 is a schematic view illustrating an entire point service system;

FIG. 2 is a front view of an IC card used in the point service system;

FIG. 3 is a data structure diagram of the IC chip installed in the IC card;

FIG. 4 is a flowchart showing an enrollment routine for a customer;

FIG. 5 is a flow chart showing a routine for issuing a service point in a virtual store;

FIG. 6 is a flow chart showing a routine executed when a point is purchased in an actual store, that is, the IC card is used as a pre-paid card;

FIG. 7 is a flowchart showing a routine executed when the point is reduced in the virtual store;

FIG. 8 is a flowchart showing a routine executed when the point is issued in the actual store;

FIG. 9 is a flowchart showing a routine executed when the customer uses the points in the actual store;

FIG. 10 is a flowchart showing a routine executed when payment is made in the actual store with a credit card;

FIG. 11 is a flowchart showing a routine when the customer uses the points for purchasing an article in the actual store;

FIG. 12 is a flowchart showing a routine when the points issued or reduced in the actual store is calculated; and

FIG. 13 is a flowchart showing a routine when the number of the tie-up company increases.

### DETAILED DESCRIPTION OF THE PREFERRED EMBODIMENTS

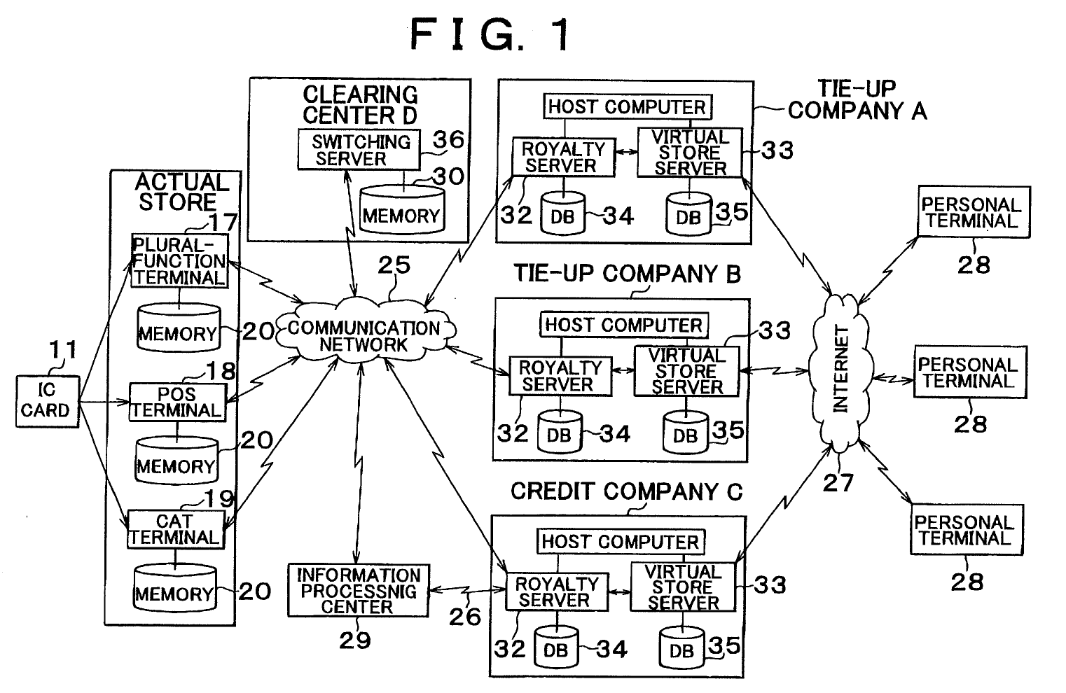

Hereinafter, the preferred embodiment of an award point (bonus point) service system of the invention will be described with reference to FIGS. 1-13.

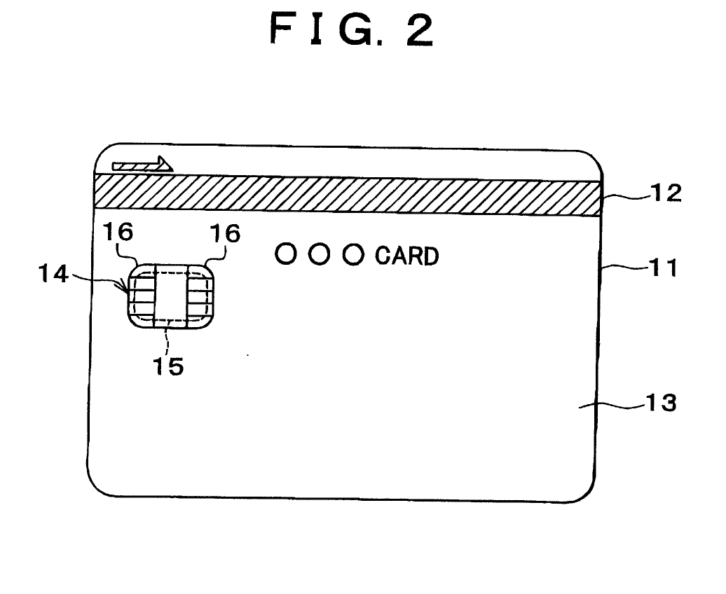

Referring to FIG. 2, a recording medium used in the point service system of this embodiment is formed as an IC card 11, which has a known magnetic stripe 12 provided on one face 13. This magnetic stripe 12 stores information based on which the IC card 11 functions as a credit card. Such information includes validity term, availability limit, and use rejection frequency, for example.

Further, the IC card 11 contains an IC module 14 having an IC chip installed therein. A plurality of external terminals 16 are provided in the surface of the IC module 14. The external terminals 16 are connected to terminals (not shown) of terminal units 17, 18, 19 to be described later so as to exchange information between read/write sections (not shown) of the terminal units 17, 18, 19 and the IC chip 15.

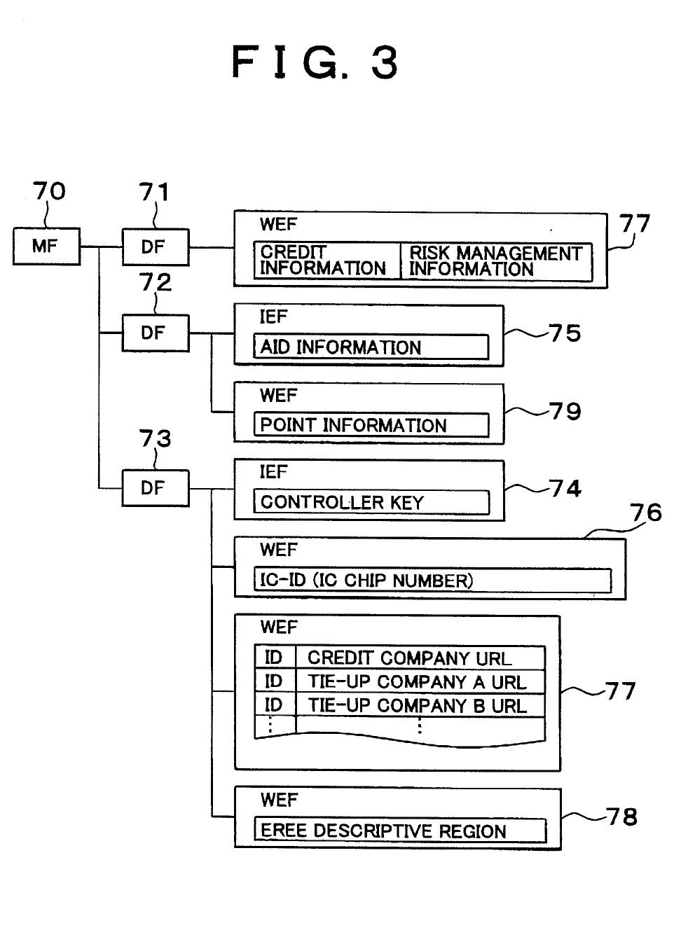

Referring to FIG. 3, the IC chip 15 is standardized in accordance with IS07816, and has a master file (hereinafter referred to as MF) 70 representing a file for an entire data memory. Three dedicated files (hereinafter referred to as DF) 71, 72, 73 for applications are stored in a lower layer of the MF 70.

An internal elementary file (hereinafter referred to as IEF) 74 as a security file and three working elementary files (hereinafter referred to as WEF) as operation files are stored in the lower layer of the DF 73. The IEF 74 contains a controller key that allows an access to the WEFs 76, 77, 78 in the DF 73. Further, the WEF 76 contains a number (hereinafter referred to as IC-ID) that identifies the IC chip. The WEF 77 contains an identification (ID) of a tie-up company and Uniform Resource Locators (URL) of that company. Further, the WEF78 is a free descriptive region, which stores member's attribute information such as a name, sex, birth date, address, telephone number, E-mail address, gold card membership, and purchase history information, point history information.

The DF 72 contains an IEF 75 which records Application Identification (AID) and an WEF 79 which records point information such as a current total point number issued in the actual store. The AID is used to restrict terminals accessible to the WEF 79. When the IC card 11 is inserted into the terminals 17, 18, 19, the terminals 17, 18, 19 check if their own AIDs match at the AID recorded in the IEF 75. This makes it possible that only the terminal having the AID matched at the AID stored in the IEF 75 is allowed to access the point information recorded in the WEF 79.

The DF 71 has substantially the same structure as that of the DF 73. The WEF 77 of the DF 71 stores the same information as that stored in the aforementioned magnetic stripe 12 and risk control information inherent of the IC credit.

The IC card 11 is connected to a plural-function terminal 17 for IC card, a terminal 18 for Point-of-Purchase (POP) system (hereinafter referred to as a POS terminal) used together with a register, or a Credit Authorization Terminal (CAT) terminal 19. The data will be read/write between those terminals and the IC card 11. Each of the terminals 17, 18, 19 has a storage portion 20 and a display screen (not shown) and acts as a second point issuing device for issuing points to a customer in an actual store. Meanwhile, the plural-function terminal 17 is provided with a mechanism for down-loading music to a mini disc (MD).

As shown in FIG. 1, at least one of the aforementioned terminals 17, 18, 19 is disposed in an actual store of the respective tie-up companies. The terminals 17, 18, 19 are connected to each royalty server 32 and each host computer 31 of the tie-up companies A, B and a credit company C through a communication network 25 such as Integrated Services Digital Network (ISDN). Here, the credit company C and one or more tie-up companies (the tie-up companies A, B are only indicated in FIG. 1) are in a tie-up relationship. Those tie-up companies have both actual and virtual stores. The number of the tie-up companies can be set within a capacity range of the WEF 77. The terminals 17, 18, 19 and the host computers 31 of the tie-up companies and the credit company are connected to an information processing center 29 dedicated for credit, for example, Credit and Finance Information Switching System (CAFIS) through the communication network 25. They are further connected to the royalty server 32 of the credit company C through a CAFIS network 26. Thus, the credit transaction information transmitted from the terminals 17, 18, 19 are received by the credit company C through the information processing center 29.

The royalty server 32 as one of reducing devices of the tie-up companies A, B and the credit company C is capable of exchanging data one another through the communication network 25 and connected to a switching server 36 at a clearing center D serving as a controller. The clearing center D has a memory portion 30 for controlling issue and reduction of points in the tie-up companies A, B and the credit company C.

The royalty server 32 of each tie-up company A, B and the credit company C is controlled by the host computer 31 having a virtual store server 33. The virtual store is established on the virtual store server 33 of the tie-up companies A, B and the credit company C. An actual store point DB 34 and a virtual store point DB 35, each serving as a recording device are connected to the royalty servers 32 and the virtual store server 33, respectively. The virtual store server 33 serves to issue a point to a customer who purchases an article in a virtual store established on the network. The virtual store server 33 is connected to a personal terminal 28, for example, a personal computer at home through the Internet 27.

Meanwhile, a system of the host computers 31 and the royalty servers 32 of the tie-up companies and the credit company as well as the terminals 17, 18 and 19 serve to permit the data access. Although in this embodiment, a business entity that holds the actual store and virtual store is referred to as a company, the entity may be an individual or a corporate body.

Next, the operation of the aforementioned point service system will be described.

(Membership)

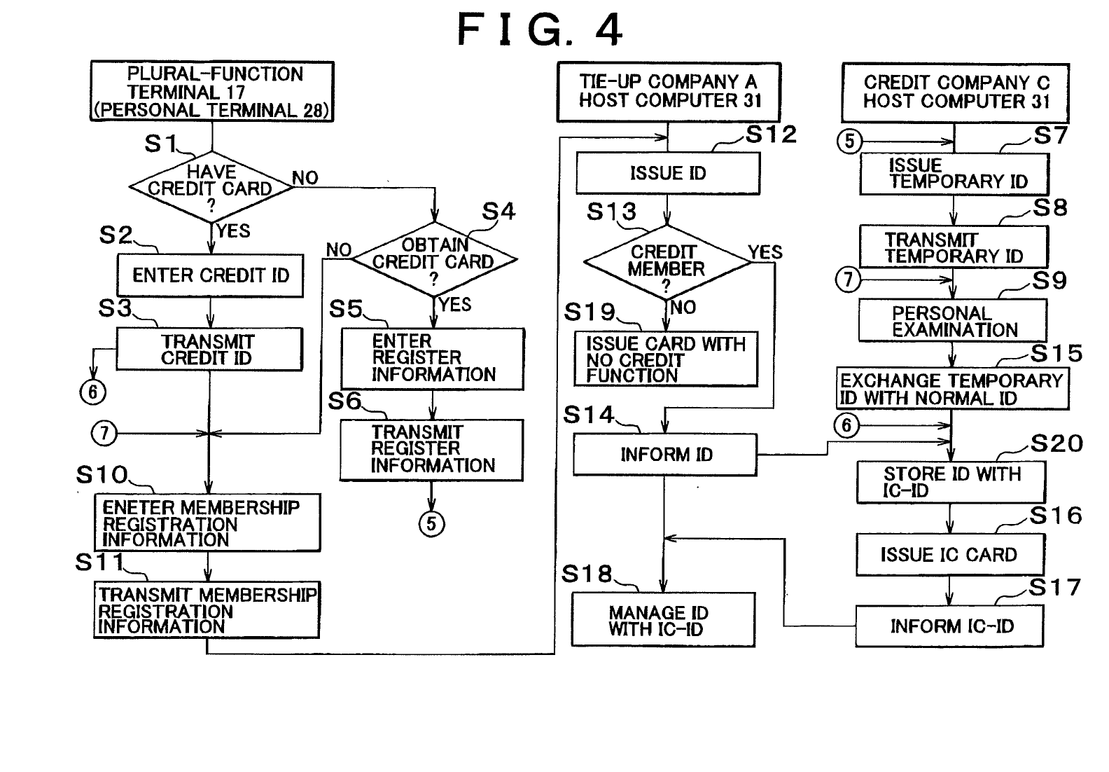

If a customer requires to become a member of the point service system of this embodiment, enrollment of membership is carried out using the terminal 17 of the tie-up company A in an actual store. Referring to a flowchart of FIG. 4, in step S1, it is determined whether a customer who wants to have a membership enrollment has a credit card of the credit company C, that is, whether the customer is a member of the credit company C. If the customer has a credit card, that is, YES obtained in step S1, The customer is asked to enter the ID of the credit card. When the ID is entered in step S2, the process proceeds to step S3. In step S3, the entered ID is sent to the credit company C through the CAFIS line 26.

If the customer does not have a credit card issued by the credit company C or a non-member of the credit company C, that is, NO is obtained in step S2, the process proceeds to step S4. In step S4, it is determined whether the customer requires to acquire the credit card. If the customer requires to acquire the credit card, that is, YES in step S4, the customer is asked to enter the enrollment information for the credit card. If the enrollment information is entered in step S5, the terminal 17 sends the entered enrollment information to the credit company C in step S6. Then in step S7, the credit company C allocates a temporary ID to the information. Next, in step S8, the temporary ID is sent back to the terminal 17 through the CAFIS line 26. Then the process proceeds to step S9, in which a personnel examination is carried out with respect to the customer. The temporary ID of the customer who passed the personnel examination is replaced by a normal ID of a credit card issued by the credit company C in step S15.

In step S10, responding to the request for entering enrollment information, the enrollment information is entered by the customer who inputs the credit card ID in step S3, the customer who requires to acquire the credit card and enters the information for the enrollment in step S8, and the customer who does not own the credit card and requires no acquirement of the credit card (NO in step S4). In step S11, the entered information is sent to the host computer 31 of the tie-up company A through the communication line 25 in step S11.

In step S12, occasionally after the personnel examination, the host computer 31 of the tie-up company A issues an ID of the tie-up company A to the customer who entered the enrollment information. If it is found that the customer who wishes the enrollment is the member of the credit company from the enrollment information entered in step S10, that is, the control schemes in steps S2, S3 or steps S7, S8 are executed (YES in S13), process proceeds to step S14. In step S14, the issued ID is sent to the credit company C. Next in step S20, upon receipt of the ID, the credit company C stores the ID together with the IC-ID in the host computer 31 of the credit company C. In step S16, the credit company C inputs various kinds of information in the IC card 11 so as to be issued. More specifically, the information that allows the IC card 11 to function as the credit card is stored in the magnetic stripe 12 and DF71. The information relating to AID (for example, indicating that a point can be issued and reduced in the tie-up company A to which the customer is required for the enrollment) is stored in the IEF 75 of the DF 72. The IF of the tie-up company A issued thereby and the ID of the credit company C are stored in the WEF 77 of the DF 73 together with the URLs of the tie-up company A and the credit company C. Meanwhile, this IC card 11 is sent to a customer who applied for the enrollment by mail, for example.

Referring to the flowchart of FIG. 4, after issue of the IC card 11, the IC-ID of the IC card 11 that stores the ID of the tie-up company A sent in step S14 is transmitted to the tie-up company A in step S17. Then in step S18, the tie-up company A controls the IC-ID in relation with the ID issued by the tie-up company A.

Meanwhile in step S19, a membership card with no credit function is issued to the customer as a non-member who applies the enrollment. The customer is also allowed to apply for the enrollment from the virtual store. In this case, such customer accesses the virtual store established in the network from the personal terminal 28. The customer then performs a series of procedures which are expected to be executed by the plural-function terminal 17 in the actual store using the personal terminal 28.

(Issuing Service Points in the Virtual Store)

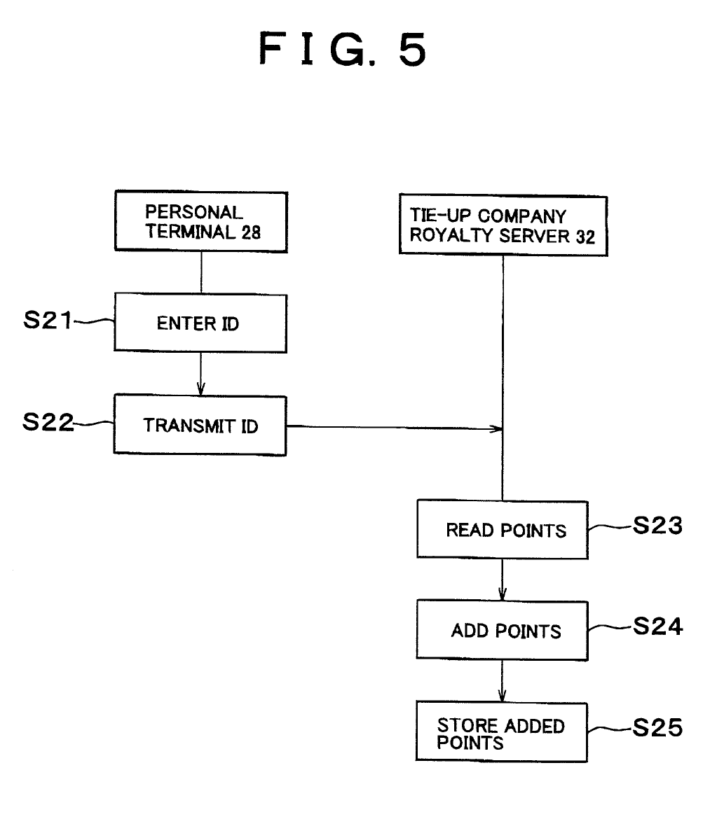

Referring to FIG. 5, issuing the service point in the virtual store of the tie-up company A will be described. The point is issued to a membership customer who purchases an article in a virtual store of the tie-up company A. The point is issued corresponding to the purchase price (for example, the point number equivalent to 10% of the purchased price is issued.).

In step S21, upon entry request for the ID of the tie-up company A, which has been already notified to the customer, the ID is entered by the customer. Then in step S22, the entered ID is sent to the virtual store server 33 of virtual store of the company A through the Internet 27. In step S23, upon receipt of the ID, the virtual store server 33 locates the IC-ID based on the entered ID such that the current points are read from the virtual store point DB 35 based on the IC-ID. In step S24, a newly issued point is added to the current point that has been read. Then, the virtual store server 33 stores the total points together with the IC-ID in the virtual store point DB 35. The issue of the service point is carried out in the virtual store of the other tie-up company in the same way as described above.

(Reducing the Service Point in the Virtual Store)

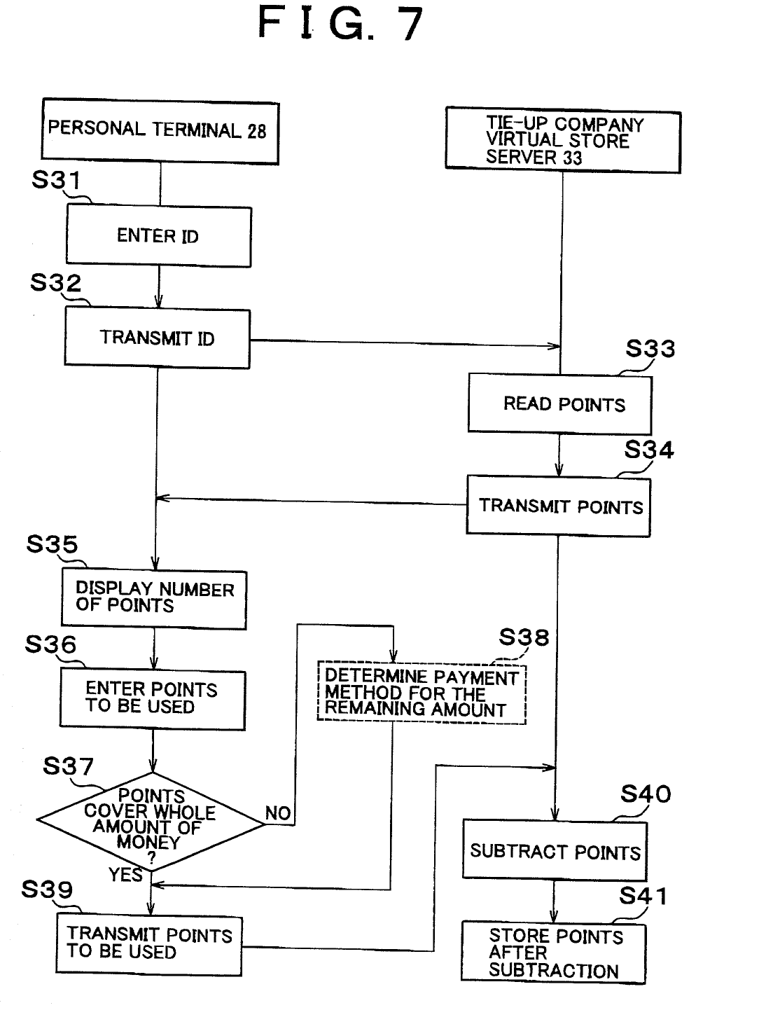

Referring to FIG. 7, reduction of service points, that is, use of the points will be described. When the customer purchases an article in the virtual store, the point is used to pay for a part of the price of the article. A service point may be exchanged with, for example, one yen by the tie-up companies A, B and the credit company C.

In step S31, upon en entry request of ID of the tie-up company, the customer enters the ID in the virtual store. Then in step S32, the ID is sent to the virtual store server 33 of the tie-up company A through the Internet 27. Then in step S33, upon receipt of the ID, the virtual store server 33 reads points stored in the virtual store point DB 35 based on the ID. In step S34, the point information is sent to the personal terminal 28 through the Internet 27. In step S35, upon receipt of the point information, the point number is displayed on the personal terminal 28, requesting the customer to enter the point number to be used.

In step S36, the point number to be used is entered and the process proceeds to step S37. In step S37, it is determined whether the point to be used can cover the whole price. Specifically, the point to be used is converted to the amount of money, and it is determined whether the converted amount is equal to or larger than the whole price. If NO is obtained in step S37, that is, the converted amount is smaller than the whole price to be paid, the process proceeds to step S38. In step S38, the customer is required to determine how the remaining amount of money is paid. The remaining amount of money may be paid with credit or in cash upon receipt of the purchased article. When the remaining amount of money is paid with credit, the ID of the credit card of the credit company C is entered.

If the entered point number covers the whole price, that is, YES is obtained in step S37, and the method for paying the remaining amount of money is determined in step S38, the point number to be used is transmitted to the virtual store server 33 of the tie-up company A through the internet 27. In this case, if the remaining amount of money is paid with the credit, the information containing the ID of the credit company C and the method for paying with the credit is transmitted to the tie-up company A. Upon receipt of the point number to be used, the virtual store server 33 subtracts the point number to be used from the current point number in step S40. The resultant point number is stored in the virtual store point DB 35 in step S41. The ID of the credit company is transmitted to the information processing center 29. The transmitted ID is further transmitted to the credit company C through the CAFIS line 26.

(Issue and Reduction of the Service Point in an Actual Store)

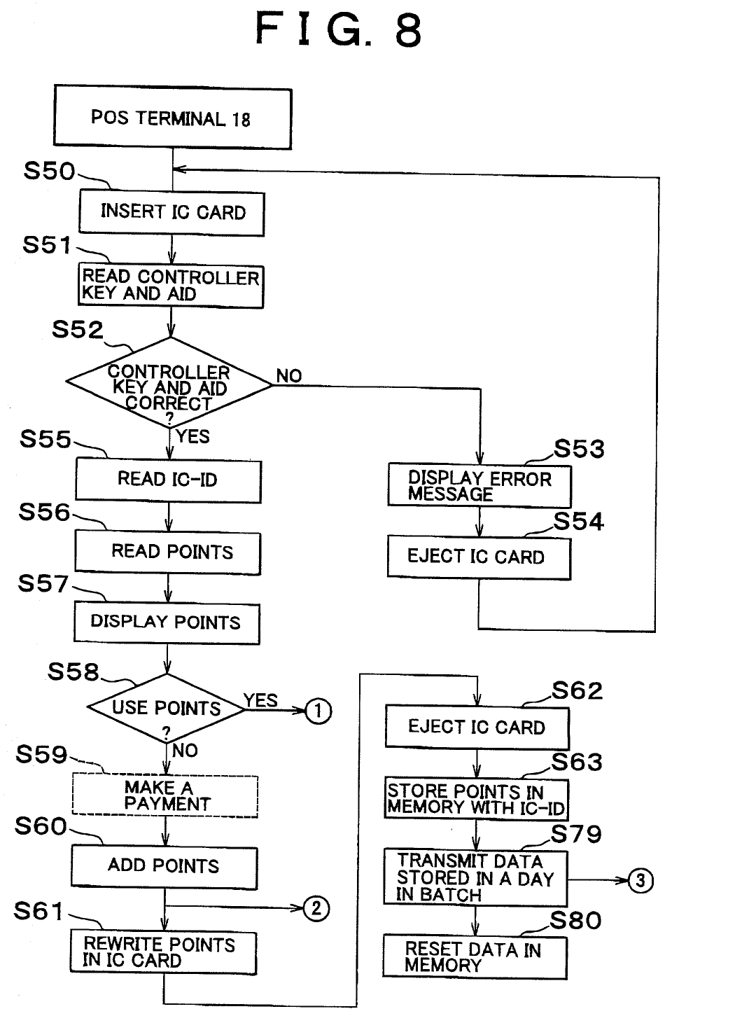

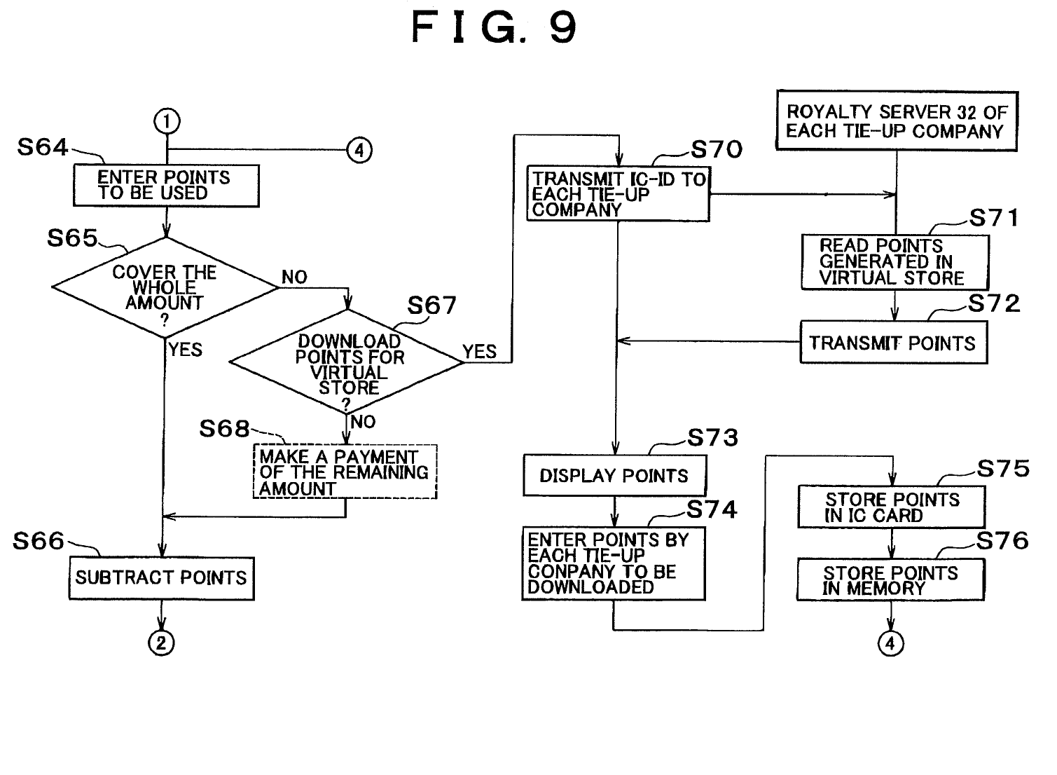

Referring to FIGS. 8 and 9, the payment for the article purchased in the actual store of the tie-up company A, in cash, point, or credit using the POS terminal 18 will be described. This also applies to the case for making a payment using the terminal 17 or 19. In this case, the point corresponding to the amount of money of the purchased price. In step S50, the IC card 11 is inserted into the POS terminal provided in the actual store.

In step S51, the POS terminal 18 reads the controller key stored in the IEF 74 and the AID stored in the IEF 75 of the IC card 11. Then in step S52, it is determined whether the controller key and the AID that have been read match at those of the POS terminal 18. If the controller key and the AID do not match at those of the POS terminal 18, that is, if NO is obtained in step S52, the process proceeds to step 53. In step S53, the error message is displayed. Then in step S54, the IC card 11 is ejected from the POS terminal 18 and returns to step S50.

If the controller key and the AID match at those of the POS terminal 18, that is, YES is obtained in step S52, the respective DFs 71, 72, 73 become accessible. In step S55, the IC-ID is read from the WEF 76 of the DF 73. In step S56, a currently stored point number is read form the WEF 79 of the DF 72. In step S57, the point number that has been read is displayed on a display portion of the POS terminal 18.

In step S58, it is determined whether the point is used. If the point is stored without using, that is, NO is obtained in step S58, the process proceeds to step S59 in which the charged amount is paid. Then in step S60, the point number is added. The thus added point number is written into the WEF 79 of the IC card 11 in step S61. In step S62, the IC card 11 is ejected, and in step S63, the information containing the added point number is stored in the storage portion 20 of the POS terminal 18.

If the point is used (YES in step S58), the point number is entered into the POS terminal 18 in step S64 of a flowchart shown in FIG. 9. Next in step S65, the entered point number is converted to an amount of money, and it is determined whether the converted amount covers the whole price. If the converted amount of money covers the whole price, that is, YES in step S65, the point number used for the payment is subtracted from the point number that has been read in step S66.

If the entered point number cannot cover the whole price, that is, NO is obtained in step S65, the process proceeds to step S67. In step S67, it is determined whether the point issued by the virtual store is required to be used. If the use of the point issued by the virtual store is not required, that is, NO in step S67, the process proceeds to step S68. In step S68, the remaining amount of money is paid. Then in step S66, the point number that has been used is subtracted from the point number that has been read.

In this embodiment, the data of the point issued by the virtual store is stored in the virtual store point DB 35, and not written in the IC card 11. If the use of the point issued by the virtual store is required, that is, YES is obtained in step S67, the process for down loading the point for the virtual store starts. Specifically, in step S70, the IC-ID stored in the WEF 76 of the DF 73 is transmitted to the royalty servers 32 of all the tie-up companies A, B and the credit company C by which the customer is able to use through the clearing center D. Next in step S71, upon receipt of the IC-ID, each royalty server 32 of the tie-up companies A, B and credit company C reads the point number issued by the virtual store from the virtual store point DB 35. Then in step S72, the point number that has been read is transmitted to the POS terminal 18. The process proceeds to step S73, in which the point number transmitted from the respective companies is displayed on a display portion of the POS terminal 18 together with the respective names of the company that holds the point. In step S74, the point number to be downloaded to the IC card 11 and the name of the tie-up company are entered. In step S75, the point number is written in the IC card 11, and in step S76, the point number and the tie-up company are stored in the storage portion 20.

When downloading of the point number issued by the virtual store is terminated, the process returns to step S64, in which the point number to be used is entered. If the point number to be used is reduced in step S66 through steps S65, S67 and S68, the process proceeds to step S62 of the flowchart of FIG. 8. In step S62, the subtracted point number is written in the IC card 11. Then in step S63, the point number is stored in the storage portion 20 together with the IC-ID.

The process proceeds to step S79, in which the data stored in the storage portion 20 of the POS terminal 18 for 24 hours from a predetermined time (for example, 3:00 a.m.) on a day to the predetermined time on the next day will be transmitted to the royalty server 32 of the actual store of the tie-up company A through the communication line 25. In this case, the information containing the payment with credit is transmitted to the credit company C via the information processing center 29. Then in step S80, the data stored in the storage portion 20, that have been transmitted to the tie-up company or the credit company C are reset.

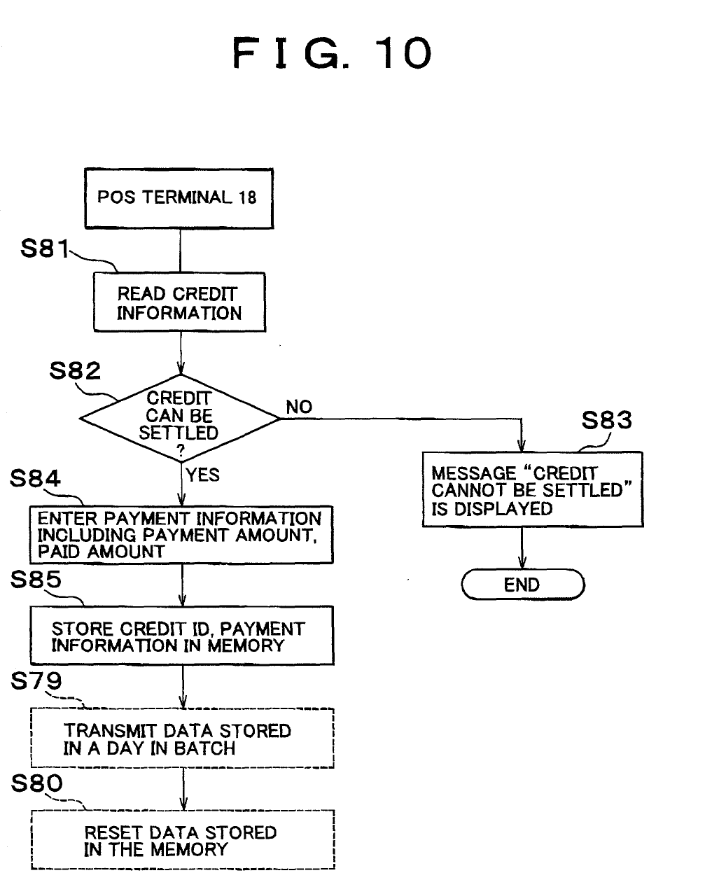

If the payment is made with credit (step S59, S68), the process shown in a flowchart of FIG. 10 will be executed. In step S81, information stored in the WEF 77 of the DF 71 is read by the POS terminal. Next in step S82, it is determined whether the settlement with credit can be made on the basis of the information. If the settlement with credit cannot be made, that is, NO is obtained in step S82, the message “settlement with credit cannot be made” is displayed on the screen of the POS terminal 18 in step S83. If the settlement with credit can be made, that is, YES in step S82, the information containing the payment method (pay in installment or lump-sum) and the amount to be paid in the installment is entered. Upon input of the payment information to the POS terminal 18 in step S84, the process proceeds to step S85 in which the card transaction process is executed, and then the sales information is stored in the storage portion 20 in response to an approval with respect to the transaction.

When data held for 24 hours are transmitted at a predetermined time, the payment information is transmitted to the credit company C through the information processing center 29 in step S79. Then in step S80,the POS terminal 18 that has transmitted the information resets the data stored in the storage portion 20.

(Use of Prepaid Card)

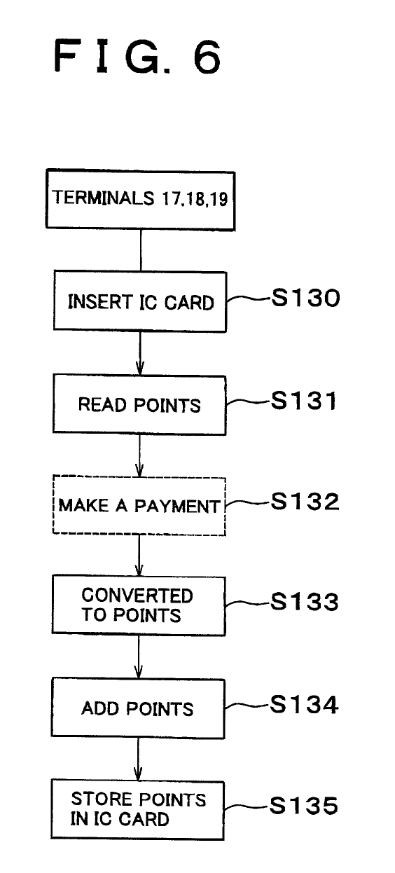

It is possible to buy the point by paying in advance so as to purchase a certain article that is available only by the point. In this case, the IC card 11 is inserted into the terminal 17 in step S130 of FIG. 6 so as to make the IC card 11 accessible. In step S131, the point number stored in the IC card 11 is read and in step S133, the amount of money that has been paid is converted into the point number. Then the converted point number is added in step S134 and the resultant total point number is stored in the WEF 79 of the IC card 11.

The IC card 11, thus, can be used as the pre-paid card in the way as described above.

(Use of the Point in the Plural-Function Terminal)

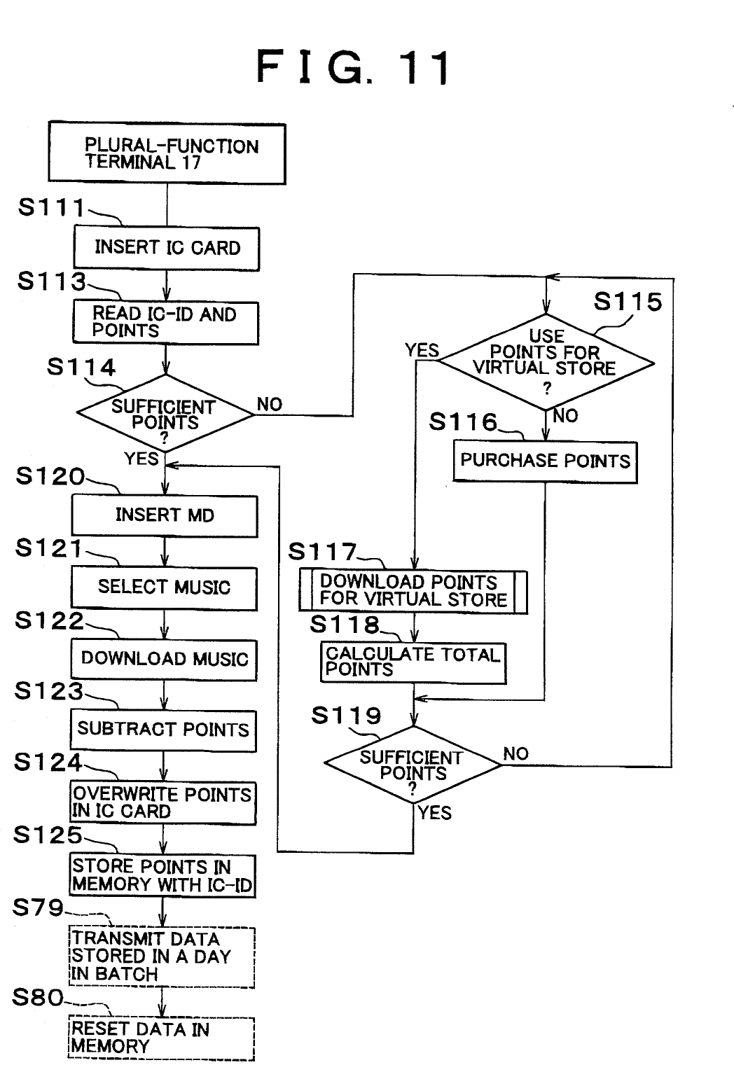

An article that is available only by the service point can be purchased through the plural-function terminal 17. For example, the music can be downloaded to an MD by the service point in accordance with the procedure shown in FIG. 11.

In step S111 of a flowchart shown in FIG. 11, the IC card 11 is inserted into the plural-function terminal 17 so as to make the IC card 11 accessible. Then in step S113, the IC-ID stored in the WEF 76 and the point information stored in the WEF 79 are read out. In step S114, it is determined whether the music can be purchased with the current point number that has been read.

If the music cannot be purchased with the current point number (the current point number is smaller than the point required for downloading the music), that is, NO is obtained in step S14, the customer (member) is asked to determine whether the point for the virtual store is used. If the customer determines not to use the point for the virtual store, that is, NO is obtained in step S115, the process proceeds to step S116. In step S116, the customer pays the remaining amount to the point until the music can be downloaded. If the customer determines to use the point number for the virtual store, that is, YES is obtained in step S115, the process proceeds to step S117. In step S117, the required point number for the virtual store is downloaded through the procedure from step S70 to step S76 shown in the flowchart of FIG. 9. Then in step S118, the downloaded point number is added to the point number stored in the IC card 11. Then in step S119, it is determined whether the total point number is larger than the required point number for downloading the music. If the total point number is still smaller than the required point, that is, NO is obtained in step S119, the process proceeds to step S115 again, in which the customer is asked to determine whether the point for the virtual store is used. If the point for the customer determines not to use the point for the virtual store, that is, NO is obtained in step S115, the process proceeds to step S116, in which the customer buys the point.

If the total point number is larger than the required point number, that is, YES is obtained in step S114, or is increased in step S116 or by buying the additional points, that is, YES is obtained in step S119, the process proceeds to step S120. In step S120, an MD is inserted into a slot of the plural-function terminal 17. Then in step S121, the music to be downloaded is selected. In step S122, the selected music is downloaded in the MD. In step S123, the point number used for downloading the music is subtracted from the current point number. Then in step S124, the resultant point number is written in the IC card 11. The subtracted point number is stored in the storage portion 20 of the plural-function terminal 17 together with the IC-ID in step S125.

Like the process for issuing and reducing the service point in the actual store, the data stored for 24 hours are transmitted to the tie-up company A that owns the plural-function terminal 17 through the communication line 25 at a predetermined time of the day in step S79. Then in step S80, the data stored in the storage portion 20 of the plural-function terminal 17 are reset.

(Processing in the Clearing Center D)

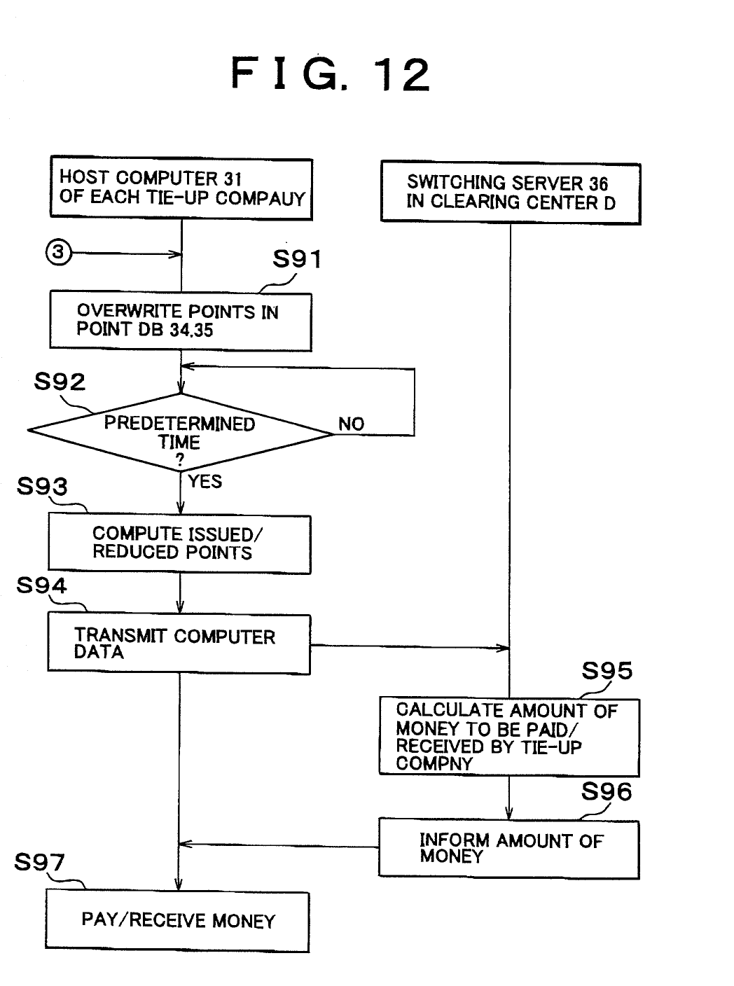

Data stored in the terminals 17, 18, 19 in the respective stores are transmitted at a predetermined time to the royalty server 32 of the tie-up company as shown in FIG. 12. In step S91, the royalty server 32 overwrites the point number stored in the actual store point DB 34 based on the received data. The data are also transmitted to the virtual store server 33 and the point number stored in the virtual store point DB 35 is overwritten in step S91.

In step S92, it is determined whether a predetermined time has come (for example, once a month). If YES is obtained in step S92, each of the tie-up companies calculates the total number of points issued and reduced by the respective tie-up companies in step S93. Then in step S94, the calculated data are transmitted to a switching server 36 of the clearing center D through the communication line 25. The process proceeds to step S95, in which the switching server 36 calculates each amount of money earned by the respective tie-up companies in accordance with numbers of points issued and reduced by those companies. More specifically, the total number of points issued by the tie-up company is subtracted from the total number of points used in the tie-up company. The obtained point number is converted into the amount of money (1point=1yen). The thus calculated amount of money is sent to the respective tie-up companies in step S96. Then in step S97, the tie-up company receives or pays the calculated amount of money when the amount is a positive value or a negative value, respectively from or to the clearing center D.

(Increase in the Tie-Up Company)

Even when a new company has joined a group of the tie-up companies after issuing the IC card 11 to a customer, the customer is not informed about the new tie-up company. In this case, when the customer uses the IC card 11 through the terminals 17, 18, 19 for the first time after the new company has joined the group the tie-up companies, the ID of the new company is written into the IC card 11.

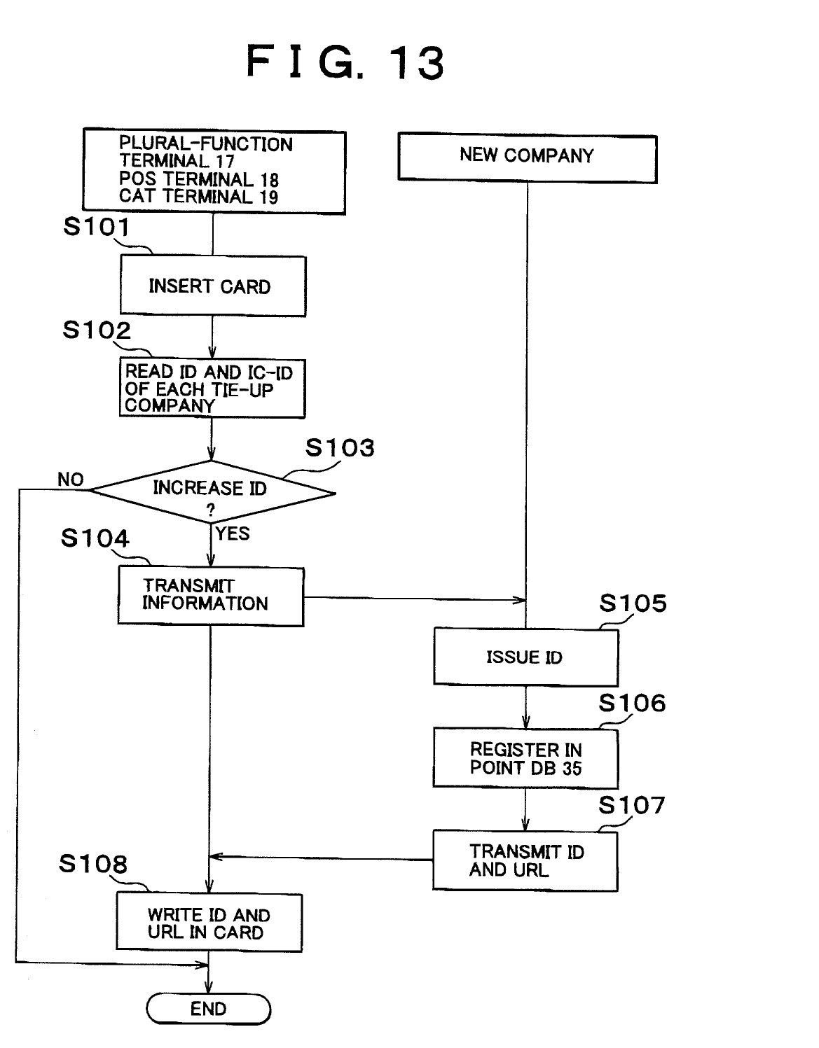

In step S101 as shown in FIG. 13, the IC card 11 is inserted into one of the terminals 17, 18, 19. In step S102, the IC-ID of the WEF 76 and ID of the respective tie-up companies A, B written in the IC card 11 are read out. If the ID of a new tie-up company is not included in the IDs that have been read, that is, the point cannot be used in the new tie-up company, the customer is notified of the newly joined company by the message like “a new company information” displayed on the display screen in step S103. The customer is then asked whether the use of the point service system in the new company is required. If the customer has no intention to use the point in the new company, NO in step S103, the routine of the flowchart shown in FIG. 13 ends. Meanwhile, when the customer shows the intention to use the point in the new company, that is, YES is obtained in step S103, the process proceeds to step S104. In step S104, the personal information stored in the IC card 11 is transmitted to the new tie-up company through the communication line 25. Then in step S105, upon receipt of the information, the new tie-up company issues an ID to the customer, i.e., the owner of the IC card 11 containing the transmitted information. The process proceeds to step S106 in which the data including the issued ID are registered in the actual store point DB 34. In step S107, the information including the newly issued ID of the new tie-up company and its URL is sent back to the terminals 17, 18, 19. Upon receipt of the transmitted information, the terminals 17, 18, 19 write the information containing the ID and URL into the WEF 77 of the DF73 of the IC card 11.

The point service system of the above-described embodiment may provide advantages as described below.

(a) The point service system allows the customer to purchase an article in an actual store with the point issued by the virtual store server 33 through the internet 27. This makes it possible to provide more attractive service to the customer and to attract the customer to purchase not only in the virtual store but also in the actual store. As a result, the sales of the actual store can be increased.

(b) The point service system includes the actual store point DB 34 and the virtual store point DB 35 for storing points by the individual members (customers). The point service system further includes the clearing center having a switching server 36 that controls points issued by the virtual store of the tie-up companies and points reduced by the actual store of the tie-up companies altogether. The switching server 36 is allowed to control points issued and reduced by the tie-up companies easily so as to clearly show the condition in which the respective tie-up companies use the point service system. This makes it possible to burden a fair operation costs to the respective companies proportional to the frequency of the access to the point service system. Accordingly, the more frequently the tie-up company accesses the system, the more cost the tie-up company has to disburse. Meanwhile, the point service system attracts the small business because of low operating costs if the access to the system is less frequently. Therefore, increasing number of companies from big business to small business are expected to join the group of the tie-up companies. The more the companies join the group, the more the customers become the members who receives the points of this system, resulting in the increased sales. Additionally the customer is able to use the points in any store held by any one of the group consisting of tie-up companies using only one card. Therefore, further increase in the customers is expected owing to improved accessibility and convenience.

(c) The point service system allows the customer to purchase an article in the actual store with points issued by the virtual store. In this case, the number of points are read through the terminals 17, 18, 19 from the virtual store point DB 35 via the royalty server 32. As the point number is read from the virtual store point DB 35 through the shortest connection, the system error may be reduced. The points issued by the virtual store are written into the IC card 11 such that the royalty server 32 controls the points written into the IC card 11. Even though the points issued by the actual store and issued by the virtual store are stored in the actual store point DB 34 and the virtual store point DB 35, individually, the point issued by the virtual store can be easily used.

(d) In the point service system, the point is issued to the customer. Therefore the customer is allowed to use the points issued by both actual and virtual stores in the actual store. As a result, the increasing number of the customers may have a chance to make a purchase in the actual store, resulting in the increased sales of the actual store.

(e) In the point service system, the number of point issued by the actual store can be read from the IC card 11 inserted into the terminals 17, 18, 19. When making a purchase in the actual store using the point issued by the actual store, the point data are transmitted between the IC card 11 and the terminals 17, 18, 19. In this case, constant communication to the royalty server 32 via the communication line 25 is not necessary, thus reducing the communication cost. Accordingly the cost for operating the point service system in the actual store can be reduced.

(f) In the point service system, the IC card 11 having an IC chip 15 installed therein is employed as a recording medium. The IC card 11 has a large storage capacity such that a large number of IDs issued by the respective tie-up companies can be stored. This makes it possible to increase the number of companies that join the group of the tie-up companies, thus increasing the sales of the store.

(g) The point service system allows the customer to make a purchase in the actual store with points issued by the actual store and the virtual store. As the number of points that can be used in the actual store is increased, the customer may have a chance to use the points in the actual store, thus increasing the sales of the actual store.

(h) The point service system allows the customer to make a purchase in the virtual store with points issued by the virtual store. This allows the customer to make a purchase in the virtual store instead of the actual store that locates far from the customer. As a result, the sales of the virtual store can be increased.

(i) The point service system allows the customer to use the point issued by any of a plurality of tie-up companies in any store held by any of the tie-up companies. As the points are issued and reduced by the tie-up companies, the sales of both the actual store and the virtual store may be promoted.

(j) In the point service system, the points issued by the actual store are stored in the actual store point DB 34, and the points issued by the virtual store are stored in the virtual store point DB 35. As the points issued by the actual store and by the virtual store are separately controlled, the point issued by the virtual store can only be used for making a purchase in the virtual store. Even if an error occurs in the use of the point in the virtual store, for example, authorization, the use of the point in the actual store is not influenced by such error.

(k) In the point service system, the point is recorded and managed in the IC card 11 that can be carried by the customer. Upon issue and use of the point in the actual store, the immediate transmission of the information to the royalty server 32 of the tie-up company is not required. The record of data for issuing and reducing the points of the customer can be transmitted together with those of the other customers altogether. Therefore the operation cost can be reduced while promoting the sales.

(l) The point service system allows the customer to download digital contents such as a music only with the points. This system also allows the customer to buy the points. As a result, the increase in the customer who desires to use the point service is expected, and the sales of each of the tie-up companies providing the point service can be increased.

(m) In the point service system, the points issued by or used in the actual store are recorded in the IC card 11. This makes it possible to identify the member and show the number of points immediately in the actual store, resulting in the enhanced accessibility.

(n) In the point service system, the information containing the controller key and the AID is recorded in the IC card 11. The customer is allowed to access the respective WEF 76 to 79 only when those data are correctly identified. Therefore each ID of the tie-up companies and the member's personal information concerning the credit can be kept in strict secrecy. Meanwhile, if the entered data including the controller key are correct, the information stored in the WEF 76 to 79 can be easily accessed.

(o) In the point service system, each URL of the tie-up companies is stored in the WEF 77 of the DF 73 together with the corresponding ID. Supposing that the personal terminal 28 is structured to read and write the information stored in the IC card 11, the information can be accessed only by reading the URL through the personal terminal 28 without entering the ID. If the increasing number of customers use the will be further enhanced.

(p) In the point service system, each ID of the respective tie-up companies is correlated with one another via the IC-ID. In the case where an error such as loss or damage of the IC card 11 occurs, the credit company informs the tie-up companies of the IC-ID and the cause of the error so as to cope with the error immediately. The information held in the tie-up companies is shared among those companies via the ICI-ID stored in the WEF 76. Therefore, the customer or the third party is not allowed to access the IC-ID, resulting in high security.

(q) The point service system allows the credit company that controls the IC-ID to have the information on the relationship between the customer and the tie-up companies. Therefore, the credit company is allowed to have an announcement or an inquiry to the member of the specific tie-up company quickly.

### EXAMPLE OF MODIFICATION

The above described embodiment may be modified as described below.

The plural-function terminal may be provided in a place other than the actual store of the tie-up company, for example, the road-side or the railway station platform.

The points issued by both the virtual store and the actual store are stored in a single database.

The IC card is formed of a non-contact type that optically or magnetically reads the stored information.

The point data for the virtual store are stored in the IC card.

The IC card having no credit function may be used.

The information containing the prepaid amount of money is stored in the IC card together with the point information.

The points can be purchased by paying in advance for saving the points.

Frequent connection is established between the actual store and the tie-up company for prompt settlement like the use of debit card.

Upon membership enrollment of the customer, only an ID of the tie-up company designated by the customer is issued and stored in the IC card.

The communication network such as public network or leased line except ISDN may be used for connecting the actual store, the tie-up companies, data managing system, and the like.

The credit transaction information may be transmitted to the credit company using the leased line except the CAFIS network or using no information processing center.

Upon the membership enrollment of the customer as well as the settlement on credit, the customer is required to transmit the personal information that has been kept in the tie-up credit company to the designated tie-up company in place of filling the application form with the required items. In this case, the customer does not have to enter the personal information upon the membership enrollment. This may simplify the enrollment procedure such that more customers become members of this system.

When a new company joins the group of the tie-up companies, personal information of a member is transmitted to the new company upon agreement of the member. In this case, the personal information is transmitted from the data stored in the host computer of the tie-up company or the credit company currently accessible to the IC card of the member. Therefore, the personal information does not have to be stored in the IC card. Additionally, the member is allowed to omit the procedure for entering the information even when a new company joins the group of the tie-up companies.

Upon first downloading of the information containing the number of points issued by the virtual store and the tie-up companies that manage the points, such information may be temporarily stored in a terminal. Subsequently the points for the virtual store can be downloaded from the terminal. In this case, the royalty server 32 does not have to be accessed frequently, the communication cost can be further minimized. The number of points can be downloaded into the IC card using the terminal for personal use, equipped with the device capable of reading and writing the information stored in the IC card.

The number of points may be indicated and used through a terminal without downloading the number of points into the IC card.

When using the points in the virtual store, a clearing center reads the points issued by the virtual store held by the other tie-up company, such that the points can be used in any virtual store held by any of the tie-up companies.

The points can be issued to the customer at a time other than making a purchase, for example, when the customer is newly enrolled or the customer responds to the questionnaire.

The issue rate of the points is set to a variable in accordance with a kind of the purchased article or the store that has issued the points.

The company that holds only virtual stores or the company that holds only actual stores may join the group of the tie-up companies so long as there are virtual and actual stores accessible to the award point service system.

A grade such as grade A, grade B, grade C is issued corresponding to the frequency of access to the award point service system, in place of issuing points that can be added and subtracted. In this case, upon making a purchase using the grade, the stored grade will be reduced, that is, the grade will be lowered.

What is claimed is:

1. An award point service system, comprising:
a point issuing device that issues points to a customer who purchases an article;
a memory that stores data of the points issued to the customer;
a data access permitting device that permits the data of the points issued to the customer to be read from the memory; and
a point reducing device that allows use of at least a part of the points read from the memory by subtracting the at least points from the data of the points stored in the memory; wherein
at least one virtual store established on a network is accessible to the point issuing device; and wherein
at least one actual store is accessible to the point reducing device.

2. An award point service system according to claim 1, wherein the at least one actual store is accessible to the point issuing device.

3. An award point service system according to claim 1, wherein the at least one virtual store is accessible to the point reducing device.

4. An award point service system according to claim 2, wherein the at least one virtual store is accessible to the point reducing device.

5. An award point service system according to claim 1, further comprising a managing device that manages the points issued by the point issuing device and the points reduced by the point reducing device.

6. An award point service system according to claim 2, further comprising a managing device that manages the points issued by the point issuing device and the points reduced by the point reducing device.

7. An award point service system according to claim 3, further comprising a managing device that manages the points issued by the point issuing device and the points reduced by the point reducing device.

8. An award point service system according to claim 4, further comprising a managing device that manages the points issued by the point issuing device and the points reduced by the point reducing device.

9. An award point service system according to claim 1, wherein the data access permitting device comprises a terminal provided in the actual store, and the terminal receives the data of the points from a recording medium owned by the customer and supplies the recording medium with the data of the points.

10. An award point service system according to claim 2, wherein the data access permitting device comprises a terminal provided in the actual store, and the terminal receives the data of the points from a recording medium owned by the customer and supplies the recording medium with the data of the points.

11. An award point service system according to claim 4, wherein the data access permitting device comprises a terminal provided in the actual store, and the terminal receives the data of the points from a recording medium owned by the customer and supplies the recording medium with the data of the points.

12. An award point service system according to claim 3, wherein the data access permitting device comprises a terminal provided in the actual store, and the terminal receives the data of the points from a recording medium owned by the customer and supplies the recording medium with the data of the points.

13. An award point service system according to claim 5, wherein the data access permitting device comprises a terminal provided in the actual store, and the terminal receives the data of the points from a recording medium owned by the customer and supplies the recording medium with the data of the points.

14. An award point service system according to claim 9, wherein the recording medium comprises a medium used for making a payment.

15. An award point service system according to claim 2, wherein the memory device includes a first memory that stores points issued to the customer in the virtual store and a second memory that stores points issued to the customer in the actual store.

16. An award point service system according to claim 4, wherein the memory device includes a first memory that stores points issued to the customer in the virtual store and a second memory that stores points issued to the customer in the actual store.

17. An award point service system according to claim 6, wherein the memory device includes a first memory that stores points issued to the customer in the virtual store and a second memory that stores points issued to the customer in the actual store.

18. An award point service system according to claim 10, wherein the memory device includes a first memory that stores points issued to the customer in the virtual store and a second memory that stores points issued to the customer in the actual store.

19. An award point service system, comprising:
a point issuing device that issues points to a customer who purchases an article;
a memory that stores data of the points issued to the customer;
a data access permitting device that permits the data of the points issued to the customer to be read from the memory; and
a point reducing device that allows use of at least a part of the points read from the memory by subtracting the at least points from the data of the points stored in the memory; wherein
at least one virtual store established on a network is accessible to the point reducing device; and wherein
at least one actual store is accessible to the point issuing device.

20. An award point service system according to claim 19, wherein the at least one virtual store is accessible to the point issuing device.

21. An award point service system according to claim 19, wherein the at least one actual store is accessible to the point reducing device.

22. An award point service system according to claim 20, wherein the memory includes a first memory that stores points issued to the customer in the virtual store and a second memory that stores points issued to the customer in the actual store.

23. An award point service system according to claim 19, wherein the data access permitting device comprises a terminal provided in the actual store, and the terminal receives the data of the points from a recording medium owned by the customer and supplies the recording medium with the data of the points.

24. An award point service system according to claim 20, wherein the data access permitting device comprises a terminal provided in the actual store, and the terminal receives the data of the points from a recording medium owned by the customer and supplies the recording medium with the data of the points.

25. An award point service system according to claim 21, wherein the data access permitting device comprises a terminal provided in the actual store, and the terminal receives the data of the points from a recording medium owned by the customer and supplies the recording medium with the data of the points.

26. An award point service system according to claim 23, wherein the recording medium comprises a medium used for making a payment.

27. A recording medium used in a point service system including an award point issuing device that issues points to a customer who purchases an article, a memory that stores data of the points issued to the customer, a data access permitting device that permits the data of the points issued to the customer to be read from the memory, and a point reducing device that allows use of at least a part of the points read from the memory by subtracting the at least points from the data of the points stored in the memory, wherein
the recording medium transmits and receives the data of the points to and from the data access permitting device, and wherein
the recording medium stores the points issued or reduced by any of at least one virtual store and at least one actual store.

28. A recording medium according to claim 27, comprising an IC card having an IC chip.

29. An award point service management method comprising the steps of:
issuing points to a customer who purchases an article in at least one of virtual stores established on a network;
recording the issued points; and
subtracting points used by the customer from the data of the points stored in a memory in at least one of actual stores such that the points are used by the customer for purchasing an article in the at least one of actual stores.

30. An award point service management method comprising the steps of:
issuing points to a customer who purchases an article in at least one of actual stores;
recording the issued points; and
subtracting points used by the customer from the data of the points stored in a memory in at least one of virtual stores such that the points are used by the customer for purchasing an article in the at least one of virtual stores.
